(19) United States
(12) Patent Application Publication
(10) Pub. No.: US 2019/0002271 A1
(43) Pub. Date: Jan. 3, 2019

(54) WATERPROOF CUSHIONS AND METHODS OF MAKING SAME

(71) Applicant: Soft-Tex International, Inc., Waterford, NY (US)

(72) Inventors: John BELIVEAU, Mooresville, NC (US); Jeff WANG, Shanghai (CN)

(73) Assignee: Soft-Tex International, Inc., Waterford, NY (US)

(21) Appl. No.: 16/023,258

(22) Filed: Jun. 29, 2018

Related U.S. Application Data
(60) Provisional application No. 62/526,613, filed on Jun. 29, 2017.

(51) Int. Cl. B68G 7/05; C09D 5/00; C09D 133/08; C09D 125/14; A47C 31/00; A47C 1/14; A47C 7/18; A01K 1/015; A47K 3/00

(52) U.S. Cl. CPC B68G 7/05; C09D 5/00; C09D 133/08; C09D 125/14; A47K 3/002; A47C 1/14; A47C 7/18; A01K 1/0157; A47C 31/00

(57) ABSTRACT

The disclosure provides a cushion including an outer cover defining an interior cavity, and inner filler material disposed within the interior cavity. The inner filler material may comprise at least one molded block of polyurethane foam. The outer cover and/or the inner filler material may be porous to at least water. The cushion further includes a waterproof coating to the outer surface the inner filler material and forming waterproof seal extending entirely thereabout after curing. The waterproof coating comprises butyl acrylate within the range of 17-32 wt %, styrene within the range of 13-26 wt %, and deionized water within the range of 42-70 wt % prior to curing. The waterproof coating may further include auxiliary components within the range of 0.5-8 wt % prior to curing. The auxiliary components may include acrylic acid, sodium lauryl sulfate, an emulsifier component, ammonium peroxydisulfate, sodium bicarbonate, sodium phosphate, tertiary and tributyl phosphate.

### CROSS-REFERENCE TO RELATED APPLICATION

This present application perfects and claims the benefit of U.S. Provisional Patent Application No. 62/526,613, filed on Jun. 29, 2017, the contents of which is hereby expressly incorporated herein by reference in its entirety.

### TECHNICAL FIELD

The present disclosure relates generally to the field of cushions, and more specifically, to cushions for use in wet conditions, methods of manufacturing the same, and coatings for filling materials of cushions for use in wet conditions.

### BACKGROUND OF THE DISCLOSURE

Cushions adapted for use in a wet environment, such as, for example, in conjunction with outdoor furniture or as a bath mat, are well known. One design criteria of such cushions is that they should be useable (e.g., comfortably and/or typically used) shortly after exposure to wet conditions. Unfortunately, conventional cushions which are presently available are not entirely satisfactory because, for example, internal filler material thereof tends to become and stay wet when exposed to wet conditions, thereby rendering the cushion unusable and/or uncomfortable and possibly damaging the cushion (e.g., via staining, mold and/or mildew growth and/or deterioration/breakdown of the material forming the cushion, for example). Also, conventional cushions remain undesirably wet for a long period of time after becoming wet before the cushions drying enough to be useable (e.g., comfortably and/or typically used).

While certain aspects of conventional technologies have been discussed to facilitate disclosure of the disclosure, Applicant in no way disclaims these technical aspects, and it is contemplated that the claimed disclosure may encompass one or more of the conventional technical aspects discussed herein.

In this specification, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE DISCLOSURE

The shortcomings of the prior art may be alleviated by using a waterproof cushion, coatings for filling material of waterproof cushions, and/or waterproof cushion manufacturing methods in accordance with one or more principles of the present disclosure. Briefly, the present disclosure satisfies the need for cushions that can be used in wet environments, and the need for cushions that do not remain wet for relatively long periods of time after becoming wet. The present disclosure may address one or more of the problems and deficiencies of the art discussed above. However, it is contemplated that the disclosure may prove useful in addressing other problems and deficiencies in a number of technical areas. Therefore, the claimed disclosure should not necessarily be construed as limited to addressing any of the particular problems or deficiencies discussed herein.

Certain embodiments of the presently-disclosed waterproof cushions, coating for filling material of waterproof cushions, and methods of making waterproof cushions have several features, no single one of which is solely responsible for their desirable attributes. Without limiting the scope of the waterproof cushions, coating for filling material of waterproof cushions, and methods of making waterproof cushions, their more prominent features will now be discussed briefly. After considering this discussion, and particularly after reading the section of this specification entitled “Detailed Description of the Disclosure,” one will understand how the features of the various embodiments disclosed herein provide a number of advantages over the current state of the art.

In one aspect, the present disclosure provides waterproof cushions comprised of a coated inner filing material and an outer covering that encases, encloses or extends about (e.g., fully or partially) the coated inner filing material. The term “cushion” as referred to herein refers to any construct, used as a comfortable support for standing, sitting or leaning on, comprising a mass of relatively flexible, resilient and/or soft inner filling material covered with a relatively flexible, resilient and/or soft and thin covering. A cushion may be a seat cushion, mat, mattress, pillow or other construction that includes an outer cover and filler material contained therein. For example, a waterproof cushion constructed in accordance with one or more aspects of the present invention may be used, for example, as a seat cushion, bath mat, dog bed, mattress topper, mattress, pillow, yoga mat, boat cushion, car mat, gardening mat and automobile and/or boat seats. In one embodiment, a waterproof cushion according to the present disclosure includes a coated inner filler material (e.g., at least one foam block) that is configured to normally remain dry even when the cushion is exposed to wet conditions or environment (i.e., is exposed to water (liquid or vapor) or any other liquid/ vapor.

In another aspect, the present disclosure provides a cushion comprising an outer cover defining an interior cavity, and an inner filler material disposed within the interior cavity and including an outer surface. The cushion further comprises a waterproof coating applied to the outer surface of said inner filler material and forming waterproof seal extending entirely about the inner filler material after curing of the coating. The waterproof coating comprises butyl acrylate within the range of 10-40 wt %, styrene within the range of 6-35 wt %, and deionized water within the range of 38-79 wt % prior to curing.

In some embodiments, said waterproof coating further comprises auxiliary components within the range of 0.5-8 wt % prior to curing, and said auxiliary components comprise at least one of acrylic acid, sodium lauryl sulfate, an emulsifier component, ammonium peroxydisulfate, sodium phosphate, tertiary and tributyl phosphate. In some such embodiments, said auxiliary components comprise acrylic acid within the range of 1.2-2 wt %, sodium lauryl sulfate within the range of 0.18-0.3 wt %, emulsifier OP-7 as the emulsifier component within the range of 0.2-0.4 wt %, ammonium peroxydisulfate within the range of 0.1-0.2 wt %, sodium phosphate, tertiary within the range of 0.05-0.1 wt % and tributyl phosphate within the range of 0.05-0.1 wt % prior to curing. In some such embodiments, said auxiliary components further comprise sodium bicarbonate within the range of 0.09-0.16 wt % prior to curing. In some other such embodiments, said waterproof coating prior to curing comprises: 20-25 wt % butyl acrylate; 15-20 wt % styrene; 1-2 wt % acrylic acid; 0.2-0.3 wt % sodium lauryl sulfate; 0.3 -0.4 wt % OP-7 emulsifier; 0.1-0.2 wt % ammonium peroxydisulfate; 0.05-0.1 wt % sodium phosphate, tertiary; 0.05-0.1 wt % tributyl phosphate; and 50-60 wt % deionized water. In some such embodiments, said waterproof coating after curing is substantially void of the deionized water, and said waterproof coating comprises 50-55 wt % butyl acrylate, 39-44 wt % styrene, 3.5-4.5 wt % acrylic acid, 0.5-0.6 wt % sodium lauryl sulfate, 0.7-0.8 wt % OP-7 emulsifier, 0.3-0.4 wt % ammonium peroxydisulfate, 0.15-0.2 wt % sodium phosphate, tertiary and 0.15-0.2 wt % tributyl phosphate after curing. In some embodiments, said waterproof coating after curing is substantially void of the deionized water, and said waterproof coating comprises 39-66 wt % butyl acrylate, 30-52 wt % styrene, 2.8-4.7 wt % acrylic acid, 0.4-0.7 wt % sodium lauryl sulfate, 0.5-0.9 wt % OP-7 emulsifier, 0.3-0.5 wt % ammonium peroxydisulfate, 0.1-0.3 wt % sodium phosphate, tertiary and 0.1-0.3 wt % tributyl phosphate after curing.

In some embodiments, said inner filler material is a molded foam. In some embodiments, said inner filler material is at least one molded block of polyurethane foam, and said inner filler material and said outer cover are porous to at least water. In some embodiments, said cushion is one of a bath mat, a pet mat or a cushion of a piece of outdoor furniture. In some embodiments, said waterproof coating comprising butyl acrylate within the range of 17-29 wt %, styrene within the range of 13-23 wt %, and deionized water within the range of 42-71 wt % prior to curing. In some such embodiments, said waterproof coating is substantially void of the deionized water and comprises butyl acrylate within the range of 39-66 wt % and styrene within the range of 30-52 wt % after curing.

In another aspect, the present disclosure provides a method of manufacturing a waterproof cushion comprising providing an outer cover defining an interior cavity, and providing an inner filler material including an outer surface and being porous to at least water. The method further comprises covering the outer surface of said inner filler material with a waterproof coating, said waterproof coating applied to the outer surface of said inner filler material and forming waterproof seal extending entirely about the inner filler material after curing. The waterproof coating comprises butyl acrylate within the range of 17-32 wt %, styrene within the range of 13-26 wt %, and deionized water within the range of 42-71 wt % prior to curing. The method further comprises curing the waterproof coating covering the outer surface of said inner filler material, and inserting said coated inner filler material within the interior cavity of said outer cover.

In some embodiments, the covering the outer surface of said inner filler material comprises at least one of: brushing the waterproof coating on the outer surface of said inner filler material; spraying the waterproof coating on the outer surface of said inner filler material; and dipping said inner filler material in an open tank containing the waterproof coating. In some embodiments, said waterproof coating further comprises acrylic acid within the range of 1.2-2 wt %, sodium lauryl sulfate within the range of 0.18-0.3 wt %, an emulsifier within the range of 0.2-0.4 wt %, ammonium peroxydisulfate within the range of 0.1-0.2 wt %, sodium phosphate, tertiary within the range of 0.05-0.1 wt % and tributyl phosphate within the range of 0.05-0.1 wt % prior to curing. In some such embodiments, curing the waterproof coating includes evaporating the deionized water from the coating, and said waterproof coating comprises 39-66 wt % butyl acrylate, 30-52 wt % styrene, 2.8-4.7 wt % acrylic acid, 0.4-0.7 wt % sodium lauryl sulfate, 0.5-0.9 wt % OP-7 emulsifier, 0.3-0.5 wt % ammonium peroxydisulfate, 0.1-0.3 wt % sodium phosphate, tertiary and 0.1-0.3 wt % tributyl phosphate after curing. In some embodiments, curing the waterproof coating includes evaporating the deionized water from the coating such that the waterproof coating is substantially void of the deionized water and comprises butyl acrylate within the range of 39-66 wt % and styrene within the range of 30-52 wt %.

In another aspect, the present disclosure provides a cushion comprising an outer cover defining an interior cavity, and an inner filler material disposed within the interior cavity and including an outer surface. The cushion further comprises a waterproof coating applied to the outer surface of said inner filler material and forming waterproof seal extending entirely about the inner filler material, said waterproof coating comprising a water based coating comprising a co-polymer reacted by butyl acrylate and styrene.

In some embodiments, said inner filler material comprises molded polyurethane foam, and wherein said inner filler material and said outer cover are porous to at least water. In some embodiments, said waterproof coating comprises 39-66 wt % butyl acrylate, 30-52 wt % styrene, 2.8-4.7 wt % acrylic acid, 0.4-0.7 wt % sodium lauryl sulfate, 0.5-0.9 wt % OP-7 emulsifier, 0.3-0.5 wt % ammonium peroxydisulfate, 0.1-0.3 wt % sodium phosphate, tertiary and 0.1-0.3 wt % tributyl phosphate after curing of the coating. In some such embodiments, said waterproof coating comprises butyl acrylate within the range of 17-32 wt %, styrene within the range of 13-26 wt %, deionized water within the range of 42-71 wt %, acrylic acid within the range of 1.2-2 wt %, sodium lauryl sulfate within the range of 0.18-0.3 wt %, emulsifier OP-7 within the range of 0.2-0.4 wt %, ammonium peroxydisulfate within the range of 0.1-0.2 wt %, sodium phosphate, tertiary within the range of 0.05-0.1 wt % and tributyl phosphate within the range of 0.05-0.1 wt % prior to curing, and said waterproof coating is substantially void of the deionized water after curing.

These and other features, benefits and advantages of the present disclosure provides will become apparent from the following detailed description of the various aspects of the present disclosure provides taken in conjunction with the appended claims and the accompanying drawings. Other embodiments and aspects of the present disclosure are described in detail herein and are considered a part of the claimed inventions.

### BRIEF DESCRIPTION OF THE DRAWINGS

The subject matter, which is regarded as the disclosure, is particularly pointed out and distinctly claimed in the claims at the conclusion of the specification. The foregoing and other features, aspects, and advantages of the disclosure will be readily understood from the following detailed description taken in conjunction with the accompanying drawings, wherein:

FIG. 1 illustrates an elevational perspective view of a waterproof cushion according to certain embodiments of the present disclosure; and

FIG. 2 illustrates a cross-sectional view of the cushion of FIG. 1 as indicated therein.

### DETAILED DESCRIPTION OF THE DISCLOSURE

Aspects of the present disclosure and certain features, advantages, and details thereof, are explained more fully below with reference to the non-limiting embodiments illustrated in the accompanying drawings. Descriptions of well-known materials, fabrication tools, processing techniques, etc., are omitted so as to not unnecessarily obscure the disclosure in detail. It should be understood, however, that the detailed description and the specific example(s), while indicating embodiments of the disclosure, are given by way of illustration only, and are not by way of limitation. Various substitutions, modifications, additions and/or arrangements within the spirit and/or scope of the underlying concepts will be apparent to those skilled in the art from this disclosure.

Reference will be made below in detail to exemplary embodiments of the disclosure, examples of which are illustrated in the accompanying drawings. Wherever possible, the same reference numerals used throughout the drawings refer to the same or like aspects.

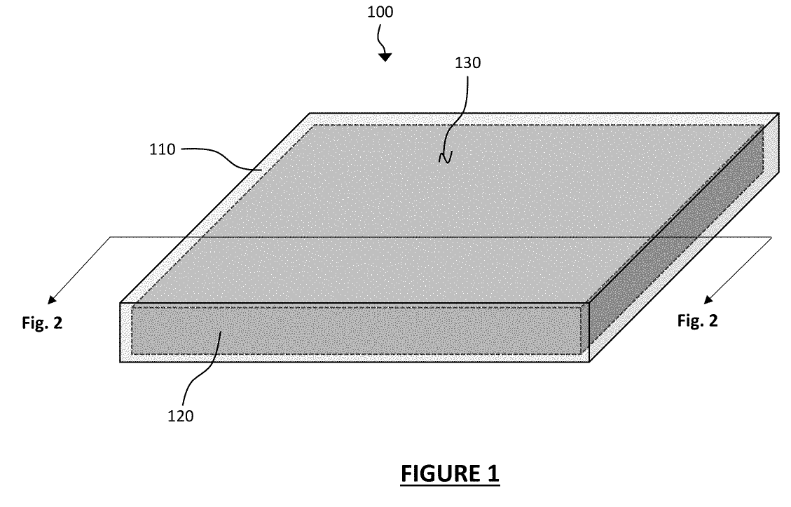

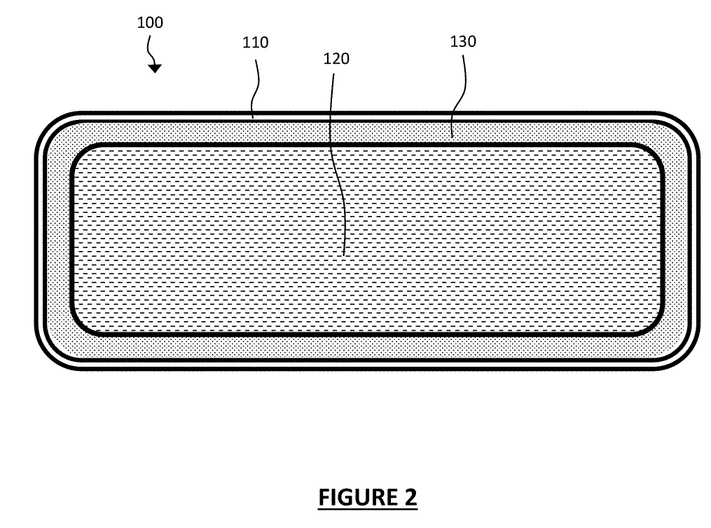

In one example, as illustrated in FIGS. 1 and 2, the present disclosure provides a waterproof cushion 100 that includes an outer cover 110 that surrounds an inner filler material 120 with an outer waterproof or super hydrophobic coating 130. The cushion is configured to be used as a comfortable support for standing, sitting or leaning on. In one embodiment, the outer cover 110 defines an interior space or cavity in which the inner filler material 120 is located, as shown in FIGS. 1 and 2. Outer cover 110 may be constructed to completely surround the inner filler material 120, and may be closed or joined to surround the filler material 120 by, for example, stitching, one or more zipper, adhesive, buttons, snaps, clasps, ties, or any other known methods of closing or jointing portions of a cover of a cushion. In other embodiments, the outer covering may only partially surround the filler material 120. In one embodiment, the outer cover 110 may include a top side and a bottom side joined at their respective peripherally extending edge regions that define the interior space. In alternative embodiments, the interior space defined by the outer cover 110 may include opposing first and second panels and a side portion or gusset perimetrically bounding and joining the first and second panels.

Outer covering 110 may be made from any material (such as woven or non-woven fabric) typically used as a cover for indoor and/or outdoor cushions. In some embodiments, the outer cover 110 may be a relatively flexible, resilient and/or soft covering. In some embodiments, the outer cover 110 may be a relatively thin covering, such as being formed from one or more sheets of fabric or other material. In some embodiments, the outer cover 110 may be waterproof or water-resistant. In other embodiments, due to a waterproof coating 130 (e.g., a super hydrophobic coating) of the inner filling 120 as further discussed below, the outer cover 110 may be porous or permeable (e.g., to water and other liquids), as shown in FIGS. 1 and 2. The outer cover 110 may be configured to wick water and other liquids. In one embodiment, the outer cover 110 may be formed of a natural and/or synthetic fabric, such as, for example, cotton, polyester, acrylic, non-woven fabric, woven fabric, knit fabric and Sunbrella® fabric. In some such embodiments, the fabric outer covering 110 may include a coating or (surface) finish. For example, in one embodiment the fabric outer covering 110 may comprise a woven fabric of (potentially dyed) acrylic fibers with a fluorocarbon finish or coating. The outer covering 110 (and the internal cavity or void formed thereby) may be any shape, size or configuration. For example, the outer covering 110 may define a thickness that is thinner or thicker than that of the filling material 120.

The inner filling material 120 of the waterproof cushion 100 may be a mass of relatively flexible, resilient and/or soft inner filling material. In some embodiments, the inner filling material 120 may be relatively stiffer/more rigid and/or harder (e.g., less easily compressed) than the outer covering 110 such that the inner filling material 120 defines the shape, size and/or configuration (at least generally or substantially) of the outer covering 110 when the outer cover 130 and the filling material 120 are assembled together (i.e., the defines the shape, size and/or configuration of the waterproof cushion 100 itself, at least generally or substantially). In other embodiments, the flexibility, resilience, stiffness and/or compressibility of the filling material 120 and the outer covering 110 may be the same, or the outer covering 110 may be relatively stiffer/more rigid and/or harder (e.g., less easily compressed) than the filling material 120 such that the outer covering 110 defines the shape, size and/or configuration of the waterproof cushion 100 itself (at least generally or substantially).

In some embodiments, the inner filling material 120 may comprise, or be formed of/from, a foam (e.g., a solid foam), for example. In some such embodiments, the inner filling material 120 may comprise, or be formed of/from, a polyurethane foam. In one embodiments, the polyurethane foam may be a memory, viscoelastic or low-resilience polyurethane foam. In one embodiment, the filling material 120 is formed of open-cell foam. In some embodiments, the inner filling material 120 may be one or more foam block, mass or sheet. If comprised of a plurality of separate and discrete pieces of foam material, the pieces may be chemically and/or mechanically adhered to each other, or the outer covering 110 may act to maintain the pieces together or in abutment. In some other embodiments, the inner filling material 120 may be formed of a fabric, batting formed of fibers, loose fiber or other fill material, or other relatively soft, flexible and/or cushioning material.

In one embodiment, a foam block(s) of the inner filling material 120 may be made from, for example, a molded foam (e.g., polyurethane foam) that defines or includes an outer surface. In some such embodiments, the inner filling material 120 formed an integral skin foam (i.e., a self-skin foam) with a relatively high-density skin and a relatively low-density core formed via an open-mold process or a closed-mold process. The foam block(s) and corresponding outer cover 130 may be formed or shaped depending on the specific application or product of the cushion 100. For example, the outer cover 130 and foam block(s) of the inner filling material 120 may be shaped as a seat cushion, bath mat, dog bed, mattress topper, mattress, pillow, yoga mat, boat cushion, car mat, gardening mat, automobile and/or boat seats or any other desired relatively comfortable support for standing, sitting or leaning on.

As also shown in FIGS. 1 and 2, the inner filling material 120 (e.g., at least one foam block) may include an outer coating 130 that is configured to seal the outer surface of the filling material 120 such that the filling material 120 remains dry even when the cushion 100 is exposed to wet conditions or environment (i.e., is exposed to water (in a liquid and/or vapor state) or any other liquid (which may be in liquid or a vapor state)). The outer coating 130 fully coats, surrounds or overlays the entire outer surface of the filling material 120 to form a waterproof or super hydrophobic barrier extending about the filling material 120 that prevents liquids from penetrating into the interior of the filling material 120 (such as into the interior of a molded polyurethane foam block or mass). In this way, the outer coating 130 is void of any voids, joints, inconsistencies, breaks or the like that would allow a liquid to flow or extend through the outer coating 130 and to/into the filling material 120. In some embodiments, at least a portion of the outer coating 130 may penetrate or extend into a portion of the interior of the filling material 120. In other embodiments, the outer coating 130 may be fully positioned on the outer surfaces of the filling material 120. In some embodiments, the outer coating 130 may include or define a substantially even or constant thickness on all the outer surfaces of the filling material 120.

In one embodiment, the waterproof coating 130 may be made by, for example, high speed mixing components thereof to make the coating 130 with a fine structure, and even or well distribution in water. In some embodiments, the waterproof coating 130, constructed as described herein and applied to the outer surface of the filling material 120 (e.g., polyurethane foam) includes (e.g., before and/or after curing), for example, a solid content greater or equal to forty-five percent, extensibility of greater or equal to three hundred percent, tensile strength of greater or equal to 1.2 Mpa, and a waterproof ability of greater than or equal to 0.3 Mpa for thirty minutes, or combinations thereof. The coating 130 may thereby advantageously include relatively high pellucidity, relatively good strength and relatively high extensibility (e.g., before and/or after curing).

In one embodiment the coating 130 may be a water-based coating including a co-polymer, such a co-polymer reacted by butyl acrylate and styrene. In some such embodiments, the coating 130 may be formed by adding butyl acrylate, styrene and water (and potentially other auxiliaries) into a reaction kettle and mixing the components at a relatively high speed, such as for example 50-200 rpm. The mixture may then be heated within the range of 80-90 degrees Celsius for an extended period of time, such as about two hours (which may cure the coating, at least partially). After heating, the mixture may be cooled down within the range 30-40 degrees Celsius. Once cooled, the co-polymer mixture may be packed.

In some embodiments, the as-applied uncured coating 130 or the mixture used to form the coating 130 may include a dosage of butyl acrylate within the range of 15-40 g including any and all ranges and subranges therein, a dosage of styrene within the range of 10-35 g including any and all ranges and subranges therein, and a dosage of water (e.g., deionized water) within the range of 50-100 g including any and all ranges and subranges therein. In some such embodiments, the as-applied uncured coating 130 or the mixture used to form the coating 130 may include a dosage of butyl acrylate within the range of 21-35 g including any and all ranges and subranges therein, a dosage of styrene within the range of 16-28 g including any and all ranges and subranges therein, and a dosage of water (e.g., deionized water) within the range of 52-88 g including any and all ranges and subranges therein. In one such embodiment, the as-applied uncured coating 130 or the mixture used to form the coating 130 may include a dosage of butyl acrylate of 28 g, a dosage of styrene of 22 g, and a dosage of water (e.g., deionized water) of 70 g.

In some embodiments, the as-applied uncured coating 130 or the mixture used to form the coating 130 may include a dosage of auxiliary components above butyl acrylate, styrene and water within the range of 0.5-6 g including any and all ranges and subranges therein, such as within the range of 0.9-5.7 g including any and all ranges and subranges therein. In some such embodiments, the as-applied uncured coating 130 or the mixture used to form the coating 130 may include a dosage of the auxiliary components within the range of 0.15-0.27 g including any and all ranges and subranges therein. In one such embodiment, the as-applied uncured coating 130 or the mixture used to form the coating 130 may include a dosage of auxiliary components of 0.21 g.

In some embodiments, the as-applied uncured coating 130 or the mixture used to form the coating 130 may include a dosage of acrylic acid as an auxiliary component (i.e., above butyl acrylate, styrene and water) within the range of 0.5-3 g including any and all ranges and subranges therein, such as within the range of 1.5-2.5 g. In one such embodiment, the as-applied uncured coating 130 or the mixture used to form the coating 130 may include a dosage of acrylic acid of 2 g. In some embodiments, the as-applied uncured coating 130 or the mixture used to form the coating 130 may include a dosage of sodium lauryl sulfate as an auxiliary component within the range of 0.1-0.5 g including any and all ranges and subranges therein, such as within the range of 0.22-0.38 g. In one such embodiment, the as-applied uncured coating 130 or the mixture used to form the coating 130 may include a dosage of sodium lauryl sulfate of 0.3 g. In some embodiments, the as-applied uncured coating 130 or the mixture used to form the coating 130 may include a dosage of an emulsifier (e.g., emulsifier OP-7) as an auxiliary component within the range of 0.1-0.8 g including any and all ranges and subranges therein, such as within the range of 0.3-0.5 g. In one such embodiment, the as-applied uncured coating 130 or the mixture used to form the coating 130 may include a dosage of an emulsifier (e.g., emulsifier OP-7) of 0.4 g. In some embodiments, the as-applied uncured coating 130 or the mixture used to form the coating 130 may include a dosage of ammonium peroxydisulfate as an auxiliary component within the range of 0.1-0.5 g including any and all ranges and subranges therein, such as within the range of 0.15-0.25 g. In one such embodiment, the as-applied uncured coating 130 or the mixture used to form the coating 130 may include a dosage of ammonium peroxydisulfate of 0.2 g. In some embodiments, the as-applied uncured coating 130 or the mixture used to form the coating 130 may include a dosage of sodium bicarbonate as an auxiliary component of less than or equal to 0.5 g including any and all ranges and subranges therein, such as less than or equal to 0.2 g. In one such embodiment, the as-applied uncured coating 130 or the mixture used to form the coating 130 may include a dosage of sodium bicarbonate of 0.15 g. In some other embodiments, the as-applied uncured coating 130 or the mixture used to form the coating 130 may not include a dosage of sodium bicarbonate. In some embodiments, the as-applied uncured coating 130 or the mixture used to form the coating 130 may include a dosage of sodium phosphate, tertiary as an auxiliary component within the range of 0.05-0.2 g including any and all ranges and subranges therein, such as within the range of 0.07-0.13 g. In one such embodiment, the as-applied uncured coating 130 or the mixture used to form the coating 130 may include a dosage of sodium phosphate, tertiary of 0.1 g. In some embodiments, the as-applied uncured coating 130 or the mixture used to form the coating 130 may include a dosage of tributyl phosphate as an auxiliary component within the range of 0.05-0.2 g including any and all ranges and subranges therein, such as within the range of 0.07-0.13 g. In one such embodiment, the as-applied uncured coating 130 or the mixture used to form the coating 130 may include a dosage of tributyl phosphate of 0.1 g.

In some embodiments, the as-applied uncured coating 130 or the mixture used to form the coating 130 may include butyl acrylate within the range of 9-40 wt % including any and all ranges and subranges therein, styrene within the range of 6-35 wt % including any and all ranges and subranges therein, and water (e.g., deionized water) within the range of 38-80 wt % including any and all ranges and subranges therein. In some such embodiments, the as-applied uncured coating 130 or the mixture used to form the coating 130 may include butyl acrylate within the range of 17-33 wt % including any and all ranges and subranges therein, styrene within the range of 13-23 wt % including any and all ranges and subranges therein, and water (e.g., deionized water) within the range of 42-72 wt % including any and all ranges and subranges therein. In one such embodiment, the as-applied uncured coating 130 or the mixture used to form the coating 130 may include 23 wt % butyl acrylate, 18 wt % styrene, 57 wt % water (e.g., deionized water), and the remaining wt % being auxiliary components. In another such embodiment, the as-applied uncured coating 130 or the mixture used to form the coating 130 may include 23 wt % butyl acrylate, 18 wt % styrene, and the remaining wt % water (e.g., deionized water) and potentially auxiliary components. In some embodiments, the as-applied uncured coating 130 or the mixture used to form the coating 130 may include auxiliary components within the range of 0.5-8 wt % above butyl acrylate, styrene and water including any and all ranges and subranges therein.

In some embodiments, the as-applied uncured coating 130 or the mixture used to form the coating 130 may include acrylic acid as an auxiliary component (i.e., above butyl acrylate, styrene and water) within the range of 0.3-4 wt % including any and all ranges and subranges therein, such as within the range of 1-2 wt %. In one such embodiment, the as-applied uncured coating 130 or the mixture used to form the coating 130 may include 1.6 wt % acrylic acid. In some embodiments, the as-applied uncured coating 130 or the mixture used to form the coating 130 may include sodium lauryl sulfate as an auxiliary component within the range of 0.05-0.7 wt % including any and all ranges and subranges therein, such as within the range of 0.18-0.3 wt %. In one such embodiment, the as-applied uncured coating 130 or the mixture used to form the coating 130 may include 0.24 wt % sodium lauryl sulfate. In some embodiments, the as-applied uncured coating 130 or the mixture used to form the coating 130 may include an emulsifier (e.g., emulsifier OP-7) as an auxiliary component within the range of 0.5-1 wt % including any and all ranges and subranges therein, such as within the range of 0.2-0.04 wt %. In one such embodiment, the as-applied uncured coating 130 or the mixture used to form the coating 130 may include 0.33 wt % an emulsifier (e.g., emulsifier OP-7). In some embodiments, the as-applied uncured coating 130 or the mixture used to form the coating 130 may include ammonium peroxydisulfate as an auxiliary component within the range of 0.05-0.7 wt % including any and all ranges and subranges therein, such as within the range of 0.12-0.2 wt %. In one such embodiment, the as-applied uncured coating 130 or the mixture used to form the coating 130 may include 0.16 wt % ammonium peroxydisulfate. In some embodiments, the as-applied uncured coating 130 or the mixture used to form the coating 130 may include sodium bicarbonate as an auxiliary component of less than or equal to 0.8 wt % including any and all ranges and subranges therein, such as within the range of 0.1-0.15 wt %. In one such embodiment, the as-applied uncured coating 130 or the mixture used to form the coating 130 may include 0.12 wt % sodium bicarbonate. In some other embodiments, the as-applied uncured coating 130 or the mixture used to form the coating 130 may not include sodium bicarbonate. In some embodiments, the as-applied uncured coating 130 or the mixture used to form the coating 130 may include sodium phosphate, tertiary as an auxiliary component within the range of 0.02-0.3 wt % including any and all ranges and subranges therein, such as within the range of 0.06-0.1 wt %. In one such embodiment, the as-applied uncured coating 130 or the mixture used to form the coating 130 may include 0.08 wt % sodium phosphate, tertiary. In some embodiments, the as-applied uncured coating 130 or the mixture used to form the coating 130 may include tributyl phosphate as an auxiliary component within the range of 0.02-0.3 wt % including any and all ranges and subranges therein, such as within the range of 0.06-0.1 wt %. In one such embodiment, the as-applied uncured coating 130 or the mixture used to form the coating 130 may include 0.08 wt % tributyl phosphate.

In some embodiments, the applied and cured coating 130 may include butyl acrylate within the range of 27-79 wt % including any and all ranges and subranges therein, styrene within the range of 18-69 wt % including any and all ranges and subranges therein. The water (e.g., deionized water) within the mixture/uncured coating may be evaporated from the coating such that that the applied and cured coating 130 is void of the water (or the water is substantially evaporated). In some such embodiments, the applied and cured coating 130 may include butyl acrylate within the range of 39-66 wt % including any and all ranges and subranges therein, styrene within the range of 30-52 wt % including any and all ranges and subranges therein, and less than or equal to 5 wt % water (e.g., deionized water) including any and all ranges and subranges therein (e.g., less than or equal to 4 wt %, 3 wt %, 2 wt %, 1% wt or being void of the water component). In one such embodiment, the applied and cured coating 130 may include 50-55 wt % butyl acrylate, 39-44 wt % styrene, and be substantially void of water. In one such embodiment, the applied and cured coating 130 may include 56 wt % butyl acrylate, 41 wt % styrene, and be substantially void of water (e.g., deionized water), and the remaining wt % being auxiliary components. In some embodiments, the applied and cured coating 130 may include auxiliary components within the range of 1-24 wt % above butyl acrylate and styrene including any and all ranges and subranges therein, such as within the range of 4-8 wt %.

In some embodiments, the applied and cured coating 130 may include acrylic acid as an auxiliary component (i.e., above butyl acrylate and styrene (and potentially water)) within the range of 0.6-11 wt % including any and all ranges and subranges therein, such as within the range of 2.5-5 wt %, 2.8-4.7 wt %, or 3.5-4.5 wt %. In one such embodiment, the applied and cured coating 130 may include 3.7-3.8 wt % acrylic acid. In some embodiments, the applied and cured coating 130 may include sodium lauryl sulfate as an auxiliary component within the range of 0.1-2 wt % including any and all ranges and subranges therein, such as within the range of 0.4-0.7 wt %. In one such embodiment, the applied and cured coating 130 may include 0.5-0.6 wt % sodium lauryl sulfate. In some embodiments, the applied and cured coating 130 may include an emulsifier (e.g., emulsifier OP-7) as an auxiliary component within the range of 0.1-3 wt % including any and all ranges and subranges therein, such as within the range of 0.5-1 wt %, or 0.5-0.9 wt %. In one such embodiment, the applied and cured coating 130 may include 0.7-0.8 wt % an emulsifier (e.g., emulsifier OP-7). In some embodiments, the applied and cured coating 130 may include ammonium peroxydisulfate as an auxiliary component within the range of 0.1-2 wt % including any and all ranges and subranges therein, such as within the range of 0.25-0.5 wt %, or 0.3-0.5 wt %. In one such embodiment, the applied and cured coating 130 may include 0.3-0.4 wt % ammonium peroxydisulfate. In some embodiments, the applied and cured coating 130 may include sodium bicarbonate as an auxiliary component of less than or equal to 5 wt % including any and all ranges and subranges therein, such as within the range of 0.2-0.4 wt %. In one such embodiment, the applied and cured coating 130 may include 0.2-0.3 wt % sodium bicarbonate. In some other embodiments, the applied and cured coating 130 may not include sodium bicarbonate. In some embodiments, the applied and cured coating 130 may include sodium phosphate, tertiary as an auxiliary component within the range of 0.05-0.8 wt % including any and all ranges and subranges therein, such as within the range of 0.1-0.3 wt %, 0.1-0.25 wt %, or 0.15-0.2 wt %. In one such embodiment, the applied and cured coating 130 may include 0.18-0.19 wt % sodium phosphate, tertiary. In some embodiments, the applied and cured coating 130 may include tributyl phosphate as an auxiliary component within the range of 0.05-0.8 wt % including any and all ranges and subranges therein, such as within the range of 0.1-0.3 wt %, 0.1-0.25 wt %, or 0.15-0.2 wt %. In one such embodiment, the applied and cured coating 130 may include 0.18-0.19 wt % tributyl phosphate.

The waterproof coating 130 may be applied to the outer surface of the inner filler material 120 in a variety of ways. Regardless of the method used, the coating 130 should be applied to completely surround and cover the inner filler material 120 (e.g., polyurethane molded foam block). The coating 130 may be applied in a thickness that ensures all aspects of the inner filler material 120 is completely surrounded or covered by the coating 130. In one example, the coating 130, after curing of the inner filler material 120 (e.g., foam material), may be brushed on the outer surface of the filler material 120. The coating 130 may be brushed onto the outer surface of the filler material 120 in angled or alternating directions (e.g., vertical and horizontal directions). Multiple coats or layers of the coating 130 may be applied to ensure all areas are sufficiently coated/sealed. The coated filler material 120 may be cured either under room conditions for several hours or, alternatively, in a heating facility such as, for example, an oven set at about forty to one hundred degrees Celsius to accelerate the curing process as compared to under room conditions.

In an alternative method, the inner filler material 120 (e.g., polyurethane molded foam block) is dipped in an open tank containing the coating material 130. In this example, the entire inner filler material 120 may be dipped into the coating material 130 for approximately five seconds, or alternatively or as long as it takes to sufficiently and thoroughly cover the inner filler material 120 (e.g., foam block). After removed from the tank, the dipped/coated inner filler material 120 may be cured either under room conditions after several hours or, alternatively, in a heating facility such as, for example, an oven set at about forty to one hundred degrees Celsius to accelerate the curing process as compared to under room conditions. The coated inner filler material 120 may be re-dipped and subsequently cured using the same curing methods for as many times/coats as it takes to ensure full coating of the inner filler material 120.

In another method, the inner filler material 120 (e.g., polyurethane molded foam block) is sprayed with the coating 130 using, for example, a spray gun. In this example, the coating 130 may sprayed on the outer surface of the inner filler material 120 (e.g., foam block) in angled or alternating directions (e.g., vertical and horizontal directions) for as many passes/coats to ensure complete coverage of the outer surface of the inner filler material 120. The sprayed inner filler material 120 may be cured either under room conditions after several hours or, alternatively, in a heating facility such as, for example, an oven set at about forty to one hundred degrees Celsius to accelerate the curing process as compared to under room conditions. The coated filler material 120 may be re-sprayed and subsequently cured using the same methods for as many times/coats as it takes to ensure full coating of the filler material 120.

After the filler material 120 is sufficiently coated with the coating 130 such that the coating 130 forms a waterproof or super hydrophobic shell or layer(s) fully surrounding the filler material 120, the coated inner filler material 120 is positioned or placed into the outer cover 110 to form the waterproof cushion 100. The waterproof cushion 100 may then, for example, be positioned or located on a piece of furniture, floor or other support surface depending on its intended use. The waterproof cushion 100 thereby includes a coated inner filler material 120 (foam mass, such as a molded polyurethane foam block(s)) that will normally remain dry even when the cushion 100 is exposed to moisture (e.g., wet weather conditions or a wet environment). Depending on the material of the outer cover 110, if the outer cover 110 becomes wet, only the outer cover 110 will need to be dried to allow the waterproof cushion 100 to be sufficient for its intended use (immediately subsequent to the improvement of the wet weather conditions or wet environment), regardless of the manner in which the cushion is located.

While embodiments of the invention have been illustrated and described in detail in the disclosure, the disclosure is to be considered as illustrative and not restrictive in character. All changes and modifications that come within the spirit of the invention are to be considered within the scope of the disclosure.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the disclosure without departing from its scope. While the dimensions and types of materials described herein are intended to define the parameters of the disclosure, they are by no means limiting and are exemplary embodiments. Many other embodiments will be apparent to those of ordinary skill in the art upon reviewing the above description. The scope of the disclosure should, therefore, be determined with reference to the appended claims, along with the full scope of equivalents to which such claims are entitled. For example, the formulas and component parts provided above with respect to the mixture for forming the waterproof coating and/or the formed waterproof coating itself may be changed by those of ordinary skill in the art to achieve different performances of a waterproof cushion constructed in accordance with one or more aspects of the present invention.

In the appended description, the terms “including” and “in which” are used as the plain-English equivalents of the respective terms “comprising” and “wherein.” Moreover, in the following claims, the terms “first,” “second,” etc. if any, are used merely as labels, and are not intended to impose numerical or positional requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

This written description uses examples to disclose several embodiments of the disclosure, including the best mode, and also to enable any person of ordinary skill in the art to practice the embodiments of disclosure, including making and using any devices or systems and performing any incorporated methods. The patentable scope of the disclosure is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

All publications cited in this specification are herein incorporated by reference as if each individual publication were specifically and individually indicated to be incorporated by reference herein as though fully set forth. Subject matter incorporated by reference is not considered to be an alternative to any claim limitations, unless otherwise explicitly indicated.

Where one or more ranges are referred to throughout this specification, each range is intended to be a shorthand format for presenting information, where the range is understood to encompass each discrete point within the range as if the same were fully set forth herein.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

We claim:

1. A cushion, said cushion comprising:
an outer cover, said outer cover defining an interior cavity;
an inner filler material, said inner filler material disposed within the interior cavity, said inner filler material including an outer surface;
a waterproof coating, said waterproof coating applied to the outer surface of said inner filler material and forming waterproof seal extending entirely about the inner filler material after curing of the coating, said waterproof coating comprising butyl acrylate within the range of 10-40 wt %, styrene within the range of 6-35 wt %, and deionized water within the range of 38-79 wt % prior to curing.

2. The cushion of claim 1, wherein said waterproof coating further comprises auxiliary components within the range of 0.5-8 wt % prior to curing, wherein said auxiliary components comprise at least one of acrylic acid, sodium lauryl sulfate, an emulsifier component, ammonium peroxydisulfate, sodium phosphate, tertiary and tributyl phosphate.

3. The cushion of claim 2, wherein said auxiliary components comprise acrylic acid within the range of 1.2-2 wt %, sodium lauryl sulfate within the range of 0.18-0.3 wt %, emulsifier OP-7 as the emulsifier component within the range of 0.2-0.4 wt %, ammonium peroxydisulfate within the range of 0.1-0.2 wt %, sodium phosphate, tertiary within the range of 0.05-0.1 wt % and tributyl phosphate within the range of 0.05-0.1 wt % prior to curing.

4. The cushion of claim 3, wherein said auxiliary components further comprise sodium bicarbonate within the range of 0.09-0.16 wt % prior to curing.

5. The cushion of claim 3, wherein said waterproof coating prior to curing comprises:
20-25 wt % butyl acrylate;
15-20 wt % styrene;
1-2 wt % acrylic acid;
0.2-0.3 wt % sodium lauryl sulfate;
0.3-0.4 wt % OP-7 emulsifier;
0.1-0.2 wt % ammonium peroxydisulfate;
0.05-0.1 wt % sodium phosphate, tertiary;
0.05-0.1 wt % tributyl phosphate; and
50-60 wt % deionized water.

6. The cushion of claim 5, wherein said waterproof coating after curing is substantially void of the deionized water, and wherein said waterproof coating comprises 50-55 wt % butyl acrylate, 39-44 wt % styrene, 3.5-4.5 wt % acrylic acid, 0.5-0.6 wt % sodium lauryl sulfate, 0.7-0.8 wt % OP-7 emulsifier, 0.3-0.4 wt % ammonium peroxydisulfate, 0.15-0.2 wt % sodium phosphate, tertiary and 0.15-0.2 wt % tributyl phosphate after curing.

7. The cushion of claim 3, wherein said waterproof coating after curing is substantially void of the deionized water, and wherein said waterproof coating comprises 39-66 wt % butyl acrylate, 30-52 wt % styrene, 2.8-4.7 wt % acrylic acid, 0.4-0.7 wt % sodium lauryl sulfate, 0.5-0.9 wt % OP-7 emulsifier, 0.3-0.5 wt % ammonium peroxydisulfate, 0.1-0.3 wt % sodium phosphate, tertiary and 0.1-0.3 wt % tributyl phosphate after curing.

8. The cushion of claim 1, wherein said inner filler material is a molded foam.

9. The cushion of claim 1, wherein said inner filler material is at least one molded block of polyurethane foam, wherein said inner filler material and said outer cover are porous to at least water.

10. The cushion of claim 1, wherein said cushion is one of a bath mat, a pet mat or a cushion of a piece of outdoor furniture.

11. The cushion of claim 1, wherein said waterproof coating comprising butyl acrylate within the range of 17-29 wt %, styrene within the range of 13-23 wt %, and deionized water within the range of 42-71 wt % prior to curing.

12. The cushion of claim 11, wherein said waterproof coating is substantially void of the deionized water and comprises butyl acrylate within the range of 39-66 wt % and styrene within the range of 30-52 wt % after curing.

13. A method of manufacturing a waterproof cushion, said method comprising:
providing an outer cover, said outer cover defining an interior cavity;
providing an inner filler material, said inner filler material including an outer surface and being porous to at least water;
covering the outer surface of said inner filler material with a waterproof coating, said waterproof coating applied to the outer surface of said inner filler material and forming waterproof seal extending entirely about the inner filler material after curing, said waterproof coating comprising butyl acrylate within the range of 17-32 wt %, styrene within the range of 13-26 wt %, and deionized water within the range of 42-71 wt % prior to curing;
curing the waterproof coating covering the outer surface of said inner filler material; and
inserting said coated inner filler material within the interior cavity of said outer cover.

14. The method of claim 13, wherein the covering the outer surface of said inner filler material comprises at least one of:
brushing the waterproof coating on the outer surface of said inner filler material;
spraying the waterproof coating on the outer surface of said inner filler material; and
dipping said inner filler material in an open tank containing the waterproof coating.

15. The method of claim 13, wherein said waterproof coating further comprises acrylic acid within the range of 1.2-2 wt %, sodium lauryl sulfate within the range of 0.18-0.3 wt %, an emulsifier within the range of 0.2-0.4 wt %, ammonium peroxydisulfate within the range of 0.1-0.2 wt %, sodium phosphate, tertiary within the range of 0.05-0.1 wt % and tributyl phosphate within the range of 0.05-0.1 wt % prior to curing.

16. The method of claim 15, wherein curing the waterproof coating includes evaporating the deionized water from the coating, and wherein said waterproof coating comprises 39-66 wt % butyl acrylate, 30-52 wt % styrene, 2.8-4.7 wt % acrylic acid, 0.4-0.7 wt % sodium lauryl sulfate, 0.5-0.9 wt % OP-7 emulsifier, 0.3-0.5 wt % ammonium peroxydisulfate, 0.1-0.3 wt % sodium phosphate, tertiary and 0.1-0.3 wt % tributyl phosphate after curing.

17. The method of claim 13, wherein curing the waterproof coating includes evaporating the deionized water from the coating such that the waterproof coating is substantially void of the deionized water and comprises butyl acrylate within the range of 39-66 wt % and styrene within the range of 30-52 wt %.

18. A cushion, said cushion comprising:
an outer cover, said outer cover defining an interior cavity;
an inner filler material, said inner filler material disposed within the interior cavity, said inner filler material including an outer surface; and
a waterproof coating, said waterproof coating applied to the outer surface of said inner filler material and forming waterproof seal extending entirely about the inner filler material, said waterproof coating comprising a coating comprising a co-polymer reacted by butyl acrylate and styrene.

19. The cushion of claim 18, wherein said inner filler material comprises molded polyurethane foam, and wherein said inner filler material and said outer cover are porous to at least water.

20. The cushion of claim 18, wherein said waterproof coating comprises 39-66 wt % butyl acrylate, 30-52 wt % styrene, 2.8-4.7 wt % acrylic acid, 0.4-0.7 wt % sodium lauryl sulfate, 0.5-0.9 wt % OP-7 emulsifier, 0.3-0.5 wt % ammonium peroxydisulfate, 0.1-0.3 wt % sodium phosphate, tertiary and 0.1-0.3 wt % tributyl phosphate after curing of the coating.

21. The cushion of claim 20, wherein said waterproof coating comprises butyl acrylate within the range of 17-32 wt %, styrene within the range of 13-26 wt %, deionized water within the range of 42-71 wt %, acrylic acid within the range of 1.2-2 wt %, sodium lauryl sulfate within the range of 0.18-0.3 wt %, emulsifier OP-7 within the range of 0.2-0.4 wt %, ammonium peroxydisulfate within the range of 0.1-0.2 wt %, sodium phosphate, tertiary within the range of 0.05-0.1 wt % and tributyl phosphate within the range of 0.05-0.1 wt % prior to curing, and wherein said waterproof coating is substantially void of the deionized water after curing.
